(19) United States
(12) Patent Application Publication
(10) Pub. No.: US 2026/0081534 A1
(43) Pub. Date: Mar. 19, 2026

(54) WIDE-RANGE EFFICIENT ISOLATED BIDIRECTIONAL CONVERTER

(71) Applicant: SHENZHEN DEEPPOWER TECHNOLOGY ENERGY CO., LTD., Shenzhen, Guangdong (CN)

(72) Inventors: Xiaolu Xiang, Shenzhen, Guangdong (CN); Junmin Li, Shenzhen, Guangdong (CN)

(21) Appl. No.: 19/109,573

(22) PCT Filed: Jun. 30, 2023
(86) PCT No.: PCT/CN2023/104830

§ 371 Date: Mar. 7, 2025

(30) Foreign Application Priority Data
Sep. 9, 2022 (CN) 202211105154.8

(51) Int. Cl. H02M 3/335; H02M 1/00; H02M 3/00

(52) U.S. Cl. CPC H02M 3/33584; H02M 1/0058; H02M 1/008; H02M 1/0095; H02M 3/01

(57) ABSTRACT

Disclosed is a wide-range efficient isolated bidirectional converter, comprising an inverter circuit, a resonance circuit, a transformer and a rectification circuit. The equivalent circuits of the resonance circuit in the wide-range efficient isolated bidirectional converter are all multi-element resonance circuits when the energy flows in the forward direction and the reverse direction, realizing soft switching when the energy flows in the forward direction and the reverse direction, with less loss, which solves the problem that the traditional LLC resonance circuit cannot work with the same performance in the reverse direction. That is, the wide-range efficient isolated bidirectional converter of the present application can boost the voltage when the energy flows in the reverse direction, can effectively boost the input/output voltage range of the converter, and realize a wide voltage range output, while the gain is the same when the energy flows in the forward direction and the reverse direction.

The present application is based on and claims the priority of the Chinese patent application No. 202211105154.8, filed on Sep. 9, 2022, the entire contents of which are hereby incorporated as a whole into the present application.

### TECHNICAL FIELD

The present application relates to the technical field of power supply conversion, and more particularly to a wide-range efficient isolated bidirectional converter.

### BACKGROUND ART

DC-DC bidirectional converter is a DC/DC converter which can adjust the bidirectional transmission of energy according to the needs. It is mainly used in the energy storage system, the vehicle power supply system, the feedback charging and discharging system, the hybrid energy electric vehicles and other occasions, with its basic requirements for achieving complete symmetry and bidirection, but also high efficiency.

In the traditional LLC resonant bidirectional converter, the ZVS conduction of the switch tube on the primary side and the ZCS conduction of the diode on the rectifier side can be realized regardless of the forward and reverse operation. However, when the energy flows in the reverse direction, the circuit characteristic is no longer the LLC resonant characteristic but degenerates to the LC resonant characteristic, and the maximum voltage gain of the LC resonance becomes 1, which greatly reduces the voltage gain in the reverse operation and can not realize the normal output in the reverse direction, so that the forward and reverse completely symmetrical bidirection can not be realized. In order to realize fully-symmetricalal bidirectional energy flow. In the industry, DAB is applied or one-stage topology circuit is added based on LLC to make up for the lack of LLC reverse gain capability and basically realize fully-symmetricalal bidirectional energy flow, but the DAB hard switch and the LLC two-stage topology will bring the problem of low efficiency. With the further development of new energy industry, the voltage range of one terminal of DC-DC bidirectional converter becomes wider and wider. In order to ensure the realization of wide-range fully-symmetrical bidirectional energy flow, it will become more difficult to achieve high efficiency, one can realize wide range. A bidirectional DC-DC topology for achieving fully-symmetrical positive and negative gains and high efficiency will be the general trend.

### SUMMARY OF THE INVENTION

The technical problem to be solved by the present application is to provide a wide-range efficient isolated bidirectional converter capable of realizing wide-range and efficient fully-symmetrical positive and negative gains.

In order to solve the above-mentioned technical problem, the present application provides a wide-range efficient isolated bidirectional converter, wherein the wide-range efficient isolated bidirectional converter includes an inverter circuit, a resonance circuit, a transformer and a rectification circuit, wherein the resonance circuit includes a first capacitor, a second capacitor, a third capacitor, a first inductor, a second inductor and a third inductor; one end of the first inductor is connected to one ends of the second inductor, the first capacitor and the third capacitor, and the other ends of the first inductor and the first capacitor are respectively connected to one ends of the third inductor and the second capacitor, and serve as a first connection end of the resonance circuit for being connected to the inverter circuit; the other ends of the second inductor and the third capacitor are respectively connected to the other ends of the third inductor and the second capacitor, and serve as a second connection end of a resonance circuit for being connected to a primary winding of a transformer; a secondary winding of the transformer is connected to an input side of a rectification circuit; and an output side of the rectification circuit and an input side of an inverter circuit serve as a second external connection end and a first external connection end of the wide-range efficient isolated bidirectional converter, respectively.

According to a further technical solution thereof, the inverter circuit includes four switch tubes; each two switch tubes are connected in series to form a bridge arm; two ends of two bridge arms are used as a first external connection end of the wide-range efficient isolated bidirectional converter after the two bridge arms are connected in parallel; and the first inductor and first capacitor are respectively connected to middle points of the two bridge arms.

According to a further technical solution thereof, the inverter circuit includes two capacitors and two switch tubes; the two capacitors and the two switch tubes are respectively connected in series to form a bridge arm; two ends of two bridge arms are used as a first external connection end of the wide-range efficient isolated bidirectional converter after the two bridge arms are connected in parallel; and the first inductor and the first capacitor are respectively connected to the middle points of the two bridge arms.

According to a further technical solution thereof, the inverter circuit includes two switch tubes; the two switch tubes are connected in series to form a bridge arm; and the first inductor and the first capacitor are respectively connected to a middle point of the bridge arm and a lowermost end/an uppermost end of the bridge arm.

According to a further technical solution thereof, the inverter circuit includes two capacitors and four switch tubes; the two capacitors and the four switch tubes are respectively connected in series to form a first bridge arm and a second bridge arm; after the first bridge arm and the second bridge arm are connected in parallel, two ends thereof serve as a first external connection end of the wide-range efficient isolated bidirectional converter; the middle point of the first bridge arm is connected to the middle point of the second bridge arm; and the first inductor and the first capacitor are respectively connected to an upper bridge arm and a lower bridge arm of the second bridge arm.

According to a further technical solution thereof, the inverter circuit includes two capacitors, four switch tubes, two diodes and a tenth capacitor; the two capacitors and the four switch tubes are respectively connected in series to form a bridge arm; two ends of the two bridge arms are used as a first external connection end of the wide-range efficient isolated bidirectional converter after the two bridge arms are connected in parallel; the first inductor and first capacitor are respectively connected to the middle points of the two bridge arms; after the two diodes are connected in series, the two diodes are connected in parallel to the tenth capacitor, and are connected in parallel to two switch tubes in the middle of the bridge arm formed by four switch tubes being connected in series; and the middle point of the bridge arm formed by the two capacitors is connected to a connection point between the two diodes connected in series.

According to a further technical solution thereof, the rectification circuit includes four switch tubes; each two switch tubes are connected in series to form a bridge arm; two ends of the two bridge arms are used as a second external connection end of the wide-range efficient isolated bidirectional converter after the two bridge arms are connected in parallel; and a same-name end and a different-name end of the secondary winding of the transformer are respectively connected to the middle points of the two bridge arms.

According to a further technical solution thereof, the wide-range efficient isolated bidirectional converter further includes a first filter capacitor and a second filter capacitor; two ends of the first filter capacitor are connected to an input side of the inverter circuit; and two ends of the second filter capacitor are connected to an output side of the rectification circuit.

In order to solve the above-mentioned technical problem, the present application also provides a wide-range efficient isolated bidirectional converter, including an inverter circuit, a resonance circuit, a transformer and a rectification circuit; the resonance circuit includes a first capacitor, a second capacitor, a first inductor, a second inductor, and a third inductor; one ends of the first inductor and the second inductor are both connected to one ends of the first capacitor and the second capacitor, and the other end of the first inductor is connected to one end of the third inductor and, together with the other end of the first capacitor, serves as a first connection end of the resonance circuit from being connected to the inverter circuit; the other end of the second inductor is connected to the other end of the third inductor and, together with the other end of the second capacitor, serves as a second connection end of the resonance circuit for being connected to a primary winding of the transformer; a secondary winding of the transformer is connected to an input side of the rectification circuit; and an output side of the rectification circuit and an input side of the inverter circuit are respectively used as a second external connection end and a first external connection end of the wide-range efficient isolated bidirectional converter.

In order to solve the above-mentioned technical problem, the present application also provides a wide-range efficient isolated bidirectional converter, including an inverter circuit, a resonance circuit, a transformer, and a rectification circuit; the resonance circuit includes a first capacitor, a second capacitor, a first inductor, a second inductor, and a third inductor; one end of the first inductor is connected to one ends of the first capacitor and the third inductor, one end of the second inductor is connected to the other end of the third inductor and one end of the second capacitor; the other end of the first inductor is connected to the other end of the second inductor and, together with the other end of the first capacitor, serves as a first connection end of the resonance circuit for being connected to the inverter circuit; the other end of the first inductor and the other end of the second capacitor serve as a second connection end of the resonance circuit, and are connected to a primary winding of the transformer; ; a secondary winding of the transformer is connected to an input side of the rectification circuit; and an output side of the rectification circuit and an input side of the inverter circuit are respectively used as a second external connection end and a first external connection end of the wide-range efficient isolated bidirectional converter.

Compared with the prior art, the equivalent circuits of the resonance circuit in the wide-range efficient isolated bidirectional converter of the present application are all multi-element resonance circuits when the energy flows in the forward direction and the reverse direction, realizing soft switching when the energy flows in the forward direction and the reverse direction, with less loss, which solves the problem that the traditional LLC resonance circuit cannot work with the same performance in the reverse direction. That is, the wide-range efficient isolated bidirectional converter of the present application can boost the voltage when the energy flows in the reverse direction, can effectively boost the input/output voltage range of the converter, and realize a wide voltage range output, while the gain is the same when the energy flows in the forward direction and the reverse direction. In addition, according to the structural design of the resonance circuit of the present application, the output of wide voltage range can be realized without wide frequency control when the switching frequency modulation control is used, i.e., the switching control frequency can be compressed and narrowed, and the efficiency can be improved.

### BRIEF DESCRIPTION OF THE DRAWINGS

FIG. 1 is a schematic circuit diagram of a first embodiment of a wide-range efficient isolated bidirectional converter of the present application.

FIG. 2 is a schematic simulation diagram of a switching frequency and an output voltage of a wide-range efficient isolated bidirectional converter of the present application in a boosted state.

FIG. 3 is a schematic simulation diagram of the switching frequency and output voltage of the wide-range efficient isolated bidirectional converter of the present application in a buck state.

FIG. 4 is a schematic circuit diagram of a second embodiment of a wide-range efficient isolated bidirectional converter of the present application.

FIG. 5 is a schematic circuit diagram of a third embodiment of a wide-range efficient isolated bidirectional converter of the present application.

FIG. 6 is a schematic circuit diagram of a fourth embodiment of a wide-range efficient isolated bidirectional converter of the present application.

FIG. 7 is a schematic circuit diagram of a fifth embodiment of a wide-range efficient isolated bidirectional converter of the present application.

FIG. 8 is a schematic circuit diagram of a sixth embodiment of a wide-range efficient isolated bidirectional converter of the present application.

### DETAILED DESCRIPTION OF THE INVENTION

The purpose, aspects, and advantages of the present application will become apparent to those skilled in the art from the following detailed description, taken in conjunction with the accompanying drawings and examples.

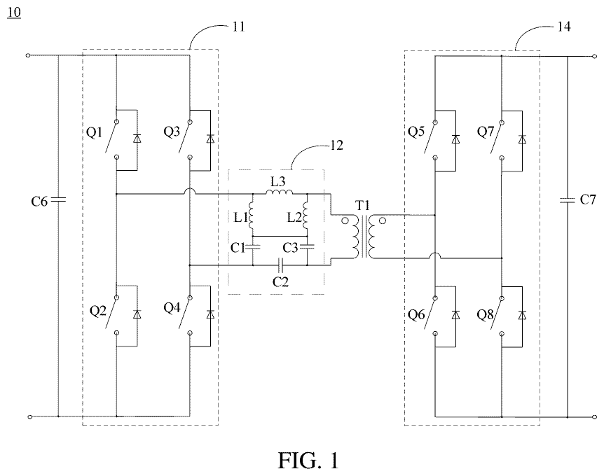

With reference to FIG. 1, FIG. 1 is a schematic circuit diagram of a first embodiment of a wide-range efficient isolated bidirectional converter 10 of the present application. In the embodiments shown in the drawings, the wide-range efficient isolated bidirectional converter 10 includes an inverter circuit 11, a resonance circuit 12, a transformer T1 and a rectification circuit 14. The resonance circuit 12 includes a first capacitor C1, a second capacitor C2, a third capacitor C3, a first inductor L1, a second inductor L2, and a third inductor L3. One end of the first inductor L1 is connected to one ends of the second inductor L2, the first capacitor C1, and the third capacitor C3, and the other end of the first inductor L1 and the first capacitor C1 is respectively connected to one ends of the third inductor L3 and the second capacitor C2, and serves as a first connection end of the resonance circuit 12 for being connected to the inverter circuit 11. The other ends of the second inductor L2 and the third capacitor C3 are respectively connected to the other ends of the third inductor L3 and the second capacitor C2, and serve as a second connection end of the resonance circuit 12 for being connected to a primary winding of the transformer T1. A secondary winding of the transformer T1 is connected to an input side of the rectification circuit 14. An output side of the rectification circuit 14 and an input side of the inverter circuit 11 respectively serve as a first external connection end and a second external connection end of the wide-range efficient isolated bidirectional converter 10 so as to connect a load and a power supply. Preferably, the inductance values of the first inductor L1 and the second inductor L2 are the same, and the capacitance values of the first capacitor C1 and the third capacitor C3 are the same. In the present embodiment, when energy flows in a forward direction, the first external connection end of the wide-range efficient isolated bidirectional converter 10 serves as a direct current input end and can be externally connected to a power supply, and the second external connection end thereof serves as a direct current output end and can be externally connected to a load. When the energy flows in the reverse direction, the second external connection end of the wide-range efficient isolated bidirectional converter 10 serves as a direct current input end, and the first external connection end thereof serves as a direct current output end.

In some embodiments, the inverter circuit 11 includes four switch tubes including a first switch tube Q1, a second switch tube Q2, a third switch tube Q3 and a fourth switch tube Q4. Each two switch tubes are connected in series to form a bridge arm. After the two bridge arms are connected in parallel, the two ends thereof serve as a first external connection end of the wide-range efficient isolated bidirectional converter 10. Specifically, in the present embodiment, the middle point of the bridge arm formed by the first switch tube Q1 and the second switch tube Q2 being connected in series is connected to a first inductor L1 and a third inductor L3. The middle point of the bridge arm formed by the third switch tube Q3 and the fourth switch tube Q4 being connected in series is connected to the first capacitor C1 and the second capacitor C2.

In the embodiment shown in the drawings, the rectification circuit 14 includes four switch tubes including a fifth switch tube Q5, a sixth switch tube Q6, a seventh switch tube Q7 and an eighth switch tube Q8. Each two switch tubes are connected in series to form a bridge arm, and two ends of the two bridge arms after being connected in parallel serve as a second external connection end of the wide-range efficient isolated bidirectional converter 10. Herein, the middle point of the bridge arm formed by the fifth switch tube Q5 and the sixth switch tube Q6 being connected in series and the middle point of the bridge arm formed by the seventh switch tube Q7 and the eighth switch tube Q8 being connected in series are respectively connected to a same-name end and a different-name end of the secondary winding of the transformer T1. With this design, when the energy flows in the forward direction, the rectification circuit 14 can rectify the voltage waveform periodically output by the transformer T1 to produce the operating voltage required by the load. Preferably, the switching transistor is a MOS, an IGBT or other controllable power switching transistor to achieve better circuit performance. In this embodiment, a diode is also connected in parallel to the switching transistor. If the switching transistor is a MOS transistor, a diode is connected in parallel between its drain and source. If the switching transistor is a IGBT transistor, a diode is connected in parallel between its emitter and collector.

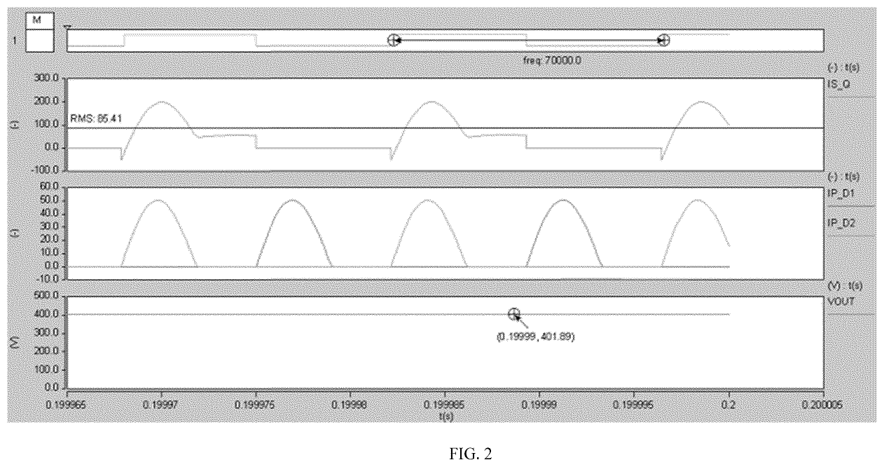

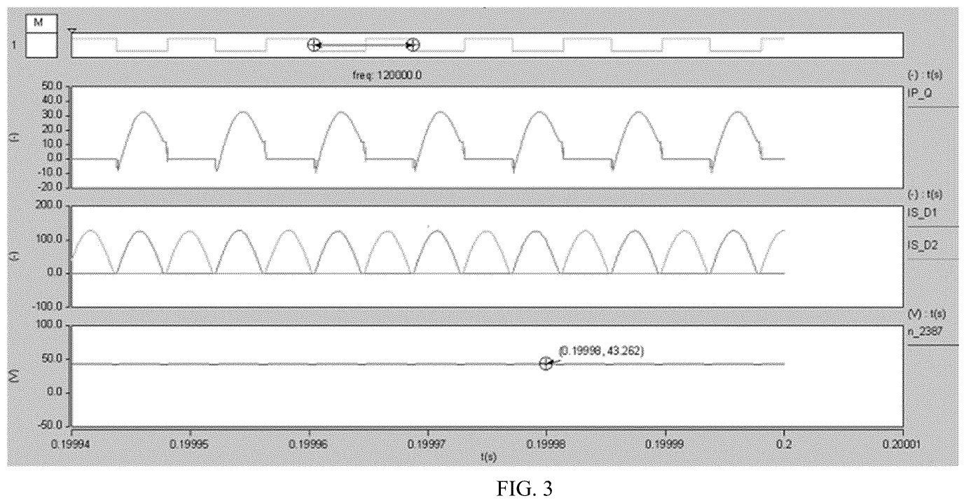

In the present embodiment, the operation of the switch tube controlled by the PFM mode, i.e., the on-time and off-time of the switch tube are kept constant by a constant duty ratio, and then a square wave frequency modulation mode is used to achieve adjustment. In the switching frequency of the bidirectional converter in the prior art, the broadband control is required to realize a wide range of input and output voltages, i.e., when it is necessary to boost 45 v to 400 v, the switching frequency needs to be fully loaded, and the frequency is as high as 200 KHZ when it is fully loaded, and as high as 250 KHZ when it is unloaded. However, the control range of the switching frequency of the wide range wide-range efficient isolated bidirectional converter in the present application is relatively small. As shown in FIG. 2, FIG. 2 is a simulation graph of a switching frequency and an output voltage when the energy flows in the forward direction and the input voltage is 45 V. In the graph, the first curve freq is a curve of the switching frequency; IS_Q is a curve of a current waveform of a direct current input end; IP_D1 is a curve of a current waveform of a fifth switch tube Q5 and an eighth switch tube Q8 in the direct current output end; IP_D2 is a curve of a current waveform of a sixth switch tube Q6 and a seventh switch tube Q7 in the direct current output end; and VOUT is an output voltage, and it can be seen that it is 401.89V, and the switching frequency freq is 70 KHZ. FIG. 3 is a simulation graph of switching frequency and output voltage when the energy flows in a reverse direction and the input voltage is 400V. The first curve freq is a curve of the switching frequency; IP_Q is a curve of current waveform of a direct current input end; IS_D1 is a curve of current waveform of a first switch tube Q1 and a fourth switch tube Q4 in a direct current output end; IS_D2 is a curve of current waveform of a third switch tube Q3 and a second switch tube Q2 in the direct current output end; the output voltage is 43.262 V, and the switching frequency freq is 120 KHZ. In summary, under the condition of the same buck-boost gain, when fully loaded, the switching frequency of the present application is smaller than that of the bidirectional converter with wide range and high efficiency isolation of the bidirectional converter in the prior art, and a wide voltage range output can be achieved without wide-frequency control. That is to say, the switching control frequency can be compressed and narrowed and the efficiency is improved.

Further, the wide-range efficient isolated bidirectional converter 10 further includes a first filter capacitor C6 and a second filter capacitor C7. Two ends of the first filter capacitor C6 are connected to an input side of the inverter circuit 11, and two ends of the second filter capacitor C7 are connected to an output side of the rectification circuit 14.

Understandably, in the present embodiment, when the energy is transmitted in the forward direction, a wide-range voltage output of the wide-range efficient isolated bidirectional converter 10 is realized by controlling the switching frequency of the first switch tube Q1, the second switch tube Q2, the third switch tube Q3 and the fourth switch tube Q4, and the two switch tubes on each bridge arm are conductive complementarily, so that a circuit soft switch can be realized. When the energy is transmitted in the reverse direction, the resonance circuit 12 is a multi-element resonance circuit. By controlling the switching frequency of the fifth switch transistor Q5, the sixth switch transistor Q6, the seventh switch transistor Q7 and the eighth switch transistor Q8, the same wide-range voltage output can be achieved as when transmitting in the forward direction, and the two switch transistors on each bridge arm are conductive complementarily, so that circuit soft switching can also be achieved.

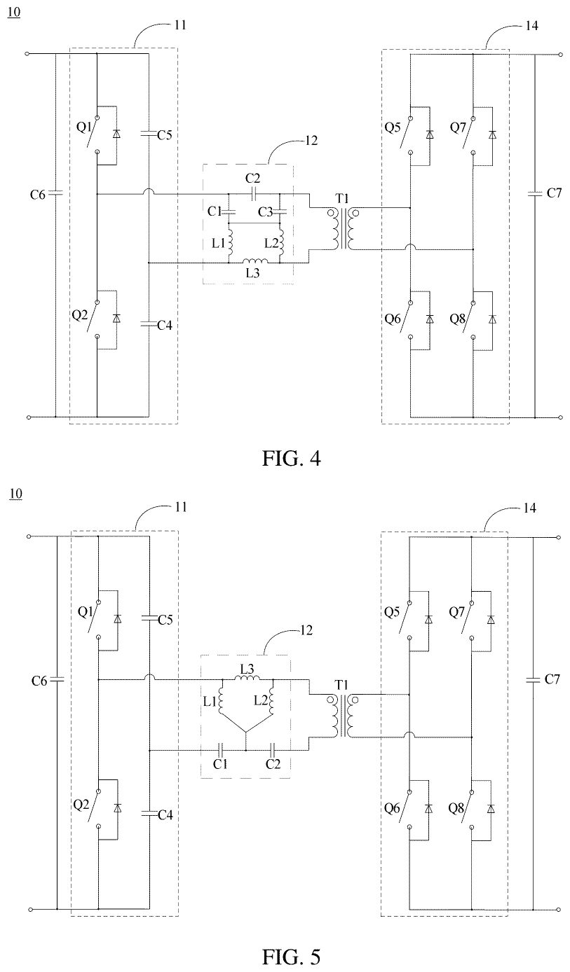

With reference to FIG. 4, FIG. 4 is a circuit schematic diagram of a second embodiment of a wide-range efficient isolated bidirectional converter 10 of the present application. The difference between the present embodiment and the first embodiment lies in the different specific structure of an inverter circuit 11 and the specific connection between a resonance circuit 12 and the inverter circuit 11 and a transformer T1 is different, and the remaining circuit structures are the same or similar. In the present embodiment, the inverter circuit 11 can also be composed of a fifth capacitor C5, a fourth capacitor C4, a first switch tube Q1 and a second switch tube Q2. The fifth capacitor C5 and the fourth capacitor C4, the first switch tube Q1 and the second switch tube Q2 are respectively connected in series to form a bridge arm. After the two bridge arms are connected in parallel, the two ends thereof serve as a first external connection end of the wide-range efficient isolated bidirectional converter 10. The middle point of the bridge arm formed by the first switch tube Q1 and the second switch tube Q2 connected in series is connected to the first capacitor C1 and the second capacitor C2. The third capacitor C3 is connected to the same-name end of the primary winding of the transformer T1. In addition, the middle point of the bridge arm formed by the fifth capacitor C5 and the fourth capacitor C4 being connected in series is connected to the first inductor L1 and the third inductor L3, and the second inductor L2 is connected to a different-name end of the primary winding of the transformer T1. In the embodiment, it also effectively boosts the input-output voltage range of the converter 10 when the energy flows in the forward and reverse directions, achieving a wide voltage range output, while retaining good soft-switching performance, and the switching control frequency can be narrowed down, improving the efficiency.

With reference to FIG. 5, FIG. 5 is a circuit schematic diagram of a third embodiment of a wide-range efficient isolated bidirectional converter 10 of the present application. The present embodiment differs from the second embodiment in that the specific structure of the resonance circuit 12 is different, and the remaining circuit structures are the same or similar. In the present embodiment, the resonance circuit 12 includes a first capacitor C1, a second capacitor C2, a first inductor L1, a second inductor L2 and a third inductor L3. One ends of the first inductor L1 and the second inductor L2 are both connected to one ends of the first capacitor C1 and the second capacitor C2, and the other end of the first inductor L1 is connected to one end of the third inductor L3 and, together with the other end of the first capacitor C1, serves as a first connection end of the resonance circuit 12 for being connected to the inverter circuit 11. The other end of the second inductor L2 is connected to the other end of the third inductor L3. The other end of the second capacitor C2 serves as a second connection end of the resonance circuit 12, and is connected to the primary winding of the transformer T1. In the present embodiment, the middle point of the bridge arm formed by the first switch tube Q1 and the second switch tube Q2 connected in series is connected to the first inductor L1 and the third inductor L3. The middle point of the bridge arm formed by of the fifth capacitor C5 and the fourth capacitor C4 connected in series is connected to the first capacitor C1. The other end of the third inductance L3 is connected to the second inductance L2 and the same-name end of the primary winding of the transformer T1, and the second capacitance C2 is connected to the different-name end of the primary winding of the transformer T1. This embodiment also effectively boosts the input-output voltage range of the converter 10 when the energy flows in the forward and reverse directions, achieving a wide voltage range output, while retaining good soft-switching performance, and the switching control frequency can be narrowed down, improving the efficiency.

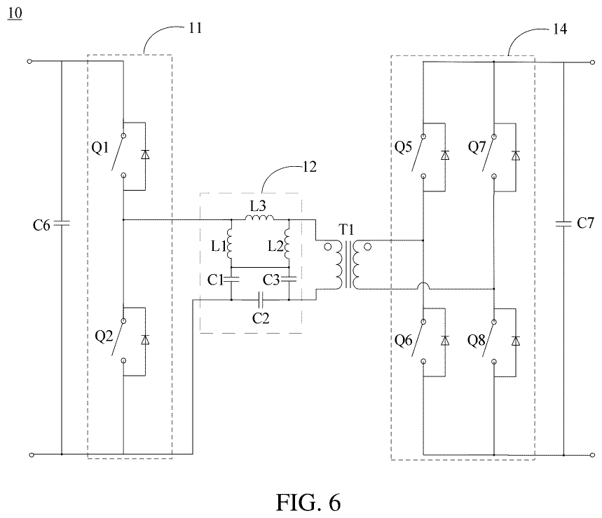

With reference to FIG. 6, FIG. 6 is a circuit schematic diagram of a fourth embodiment of a wide-range efficient isolated bidirectional converter 10 of the present application. The present embodiment differs from the first embodiment in that the specific structure of the inverter circuit 11 is different, and the remaining circuit structures are the same or similar. In the present embodiment, the inverter circuit 11 includes two switch tubes including a first switch tube Q1 and a second switch tube Q2. The first switch tube Q1 and the second switch tube Q2 are connected in series to form a bridge arm, and the first inductor L1 and the first capacitor C1 are respectively connected to the middle point of the bridge arm and the lowermost end of the bridge arm. It will be appreciated that, in some other embodiments, the first capacitor C1 may be connected to the middle point of the bridge arm and the first inductor L1 is connected to the uppermost end of the bridge arm.

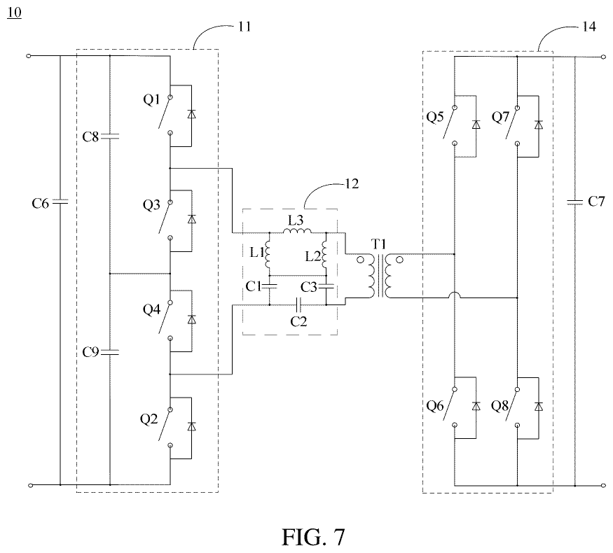

With reference to FIG. 7, FIG. 7 is a circuit schematic diagram of a fifth embodiment of a wide-range efficient isolated bidirectional converter 10 of the present application. The present embodiment differs from the first embodiment in that the specific structure of the inverter circuit 11 is different, and the remaining circuit structures are the same or similar. In the present embodiment, the inverter circuit 11 includes two capacitors and four switch tubes. The two capacitors and the four switch tubes are respectively connected in series to form a bridge arm. Specifically, the inverter circuit 11 includes an eighth capacitor C8 and a ninth capacitor C9, a first switch tube Q1, a second switch tube Q2, a third switch tube Q3 and a fourth switch tube Q4. The eighth capacitor C8 and the ninth capacitor C9 are connected in series to form a first bridge arm. The first switch tube Q1, the second switch tube Q2, the third switch tube Q3 and the fourth switch tube Q4 are connected in series to form a second bridge arm. After the two bridge arms are connected in parallel, two ends thereof serve as a first external connection end of the wide-range efficient isolated bidirectional converter 10. The middle point of the first bridge arm is connected to the middle point of the second bridge arm. The first inductor L1 and the third inductor L3 are connected to an upper bridge arm of the second bridge arm, i.e., to a connection point between the first switch tube Q1 and the third switch tube Q3. The first capacitor C1 and the second capacitor C2 are connected to a lower bridge arm of the second bridge arm, i.e., to a connection point between the fourth switch tube Q4 and the second switch tube Q2.

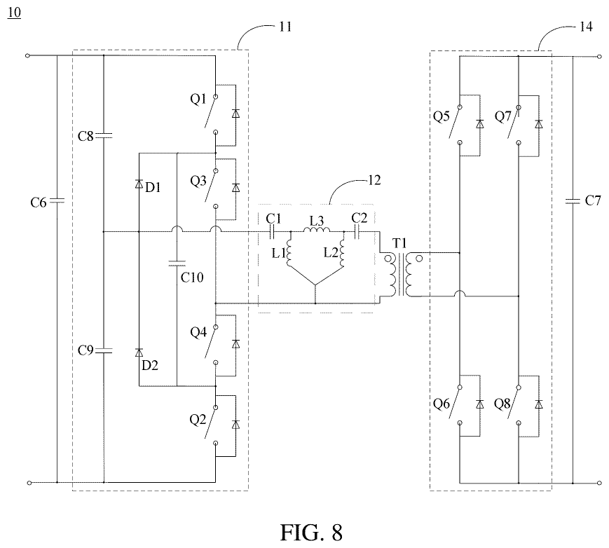

With reference to FIG. 8, FIG. 8 is a circuit schematic diagram of a sixth embodiment of a wide-range efficient isolated bidirectional converter 10 of the present application. The present embodiment differs from the first embodiment in that the specific structure of the inverter circuit 11 and the resonance circuit 12 is different, and the remaining circuit structures are the same or similar. In the present embodiment, the resonance circuit includes a first capacitor C1, a second capacitor C2, a first inductor L1, a second inductor L2 and a third inductor L3. One end of the first inductor L1 is connected to one end of the first capacitor C1 and the third inductor L3. One end of the second inductor L2 is connected to the other end of the third inductor L3 and one end of the second capacitor C2. The other end of the first inductor L1 is connected to the other end of the second inductor L2 and, together with the other end of the first capacitor C1, serves as a first connection end of the resonance circuit 12 for being connected to the inverter circuit 11. One end of the first inductor L1 connected to the second inductor L2 is connected to the different-name end of the primary winding of the transformer T1, and the other end of the second capacitor C2 is connected to the same-name end of the primary winding of the transformer T1. In addition, the inverter circuit 11 includes two capacitors, four switch tubes, two diodes and a tenth capacitor. The two capacitors and the four switch tubes are respectively connected in series to form a bridge arm. After the two bridge arms are connected in parallel, two ends thereof serve as a first external connection end of the wide-range efficient isolated bidirectional converter 10. Specifically, the inverter circuit 11 includes an eighth capacitor C8 and a ninth capacitor C9, a first switch tube Q1, a second switch tube Q2, a third switch tube Q3, a fourth switch tube Q4, a first diode D1 and a second diode D2, and a tenth capacitor C10. The middle point of the bridge arm formed by connecting the eighth capacitor C8 and the ninth capacitor C9 in series is connected to the first capacitor C1. The middle point of the bridge arm formed by connecting the first switch tube Q1, the second switch tube Q2, the third switch tube Q3, and the fourth switch tube Q4 in series is connected to a first inductor L1 and a second inductor L2. After the first diode D1 and the second diode D2 are connected in series, they are connected in parallel to the tenth capacitor C10, and connected in parallel to the third switch tube Q3 and the fourth switch tube Q4. Also, the middle point of the bridge arm formed by the eighth capacitor C8 and the ninth capacitor C9 being connected in series is connected to the connection point between the first diode D1 and the second diode D2. Namely, the middle point of the bridge arm formed by the eighth capacitor C8 and the ninth capacitor C9 being connected in series is connected to the cathode of the first diode D1 and the cathode of the second diode D2. This embodiment also effectively boosts the input-output voltage range of the converter 10 when the energy flows in the forward and reverse directions, achieving a wide voltage range output, while retaining good soft-switching performance, and the switching control frequency can be narrowed down, improving the efficiency.

In summary, the equivalent circuits of the resonance circuit in the wide-range efficient isolated bidirectional converter of the present application are all multi-element resonance circuits when the energy flows in the forward direction and the reverse direction, realizing soft switching when the energy flows in the forward direction and the reverse direction, with less loss, which solves the problem that the traditional LLC resonance circuit cannot work with the same performance in the reverse direction. That is, the wide-range efficient isolated bidirectional converter of the present application can boost the voltage when the energy flows in the reverse direction, can effectively boost the input/output voltage range of the converter, and realize a wide voltage range output, while the gain is the same when the energy flows in the forward direction and the reverse direction. In addition, according to the structural design of the resonance circuit of the present application, the output of wide voltage range can be realized without wide frequency control when the switching frequency modulation control is used, i.e., the switching control frequency can be compressed and narrowed, and the efficiency can be improved.

The foregoing is merely a preferred embodiment of the present application and is not intended to limit the present application in any way. Those skilled in the art can apply equivalent alterations and modifications to the above-described embodiments. Any equivalent alterations or modifications made within the scope of the claims shall fall within the scope of protection of the present application.

1. A wide-range efficient isolated bidirectional converter, wherein the wide-range efficient isolated bidirectional converter comprises an inverter circuit, a resonance circuit, a transformer and a rectification circuit; the resonance circuit comprises a first capacitor, a second capacitor, a third capacitor, a first inductor, a second inductor and a third inductor; one end of the first inductor is connected to one ends of the second inductor, the first capacitor and the third capacitor, and the other ends of the first inductor and the first capacitor are respectively connected to one ends of the third inductor and the second capacitor, and serve as a first connection end of the resonance circuit for being connected to the inverter circuit; the other ends of the second inductor and the third capacitor are respectively connected to the other ends of the third inductor and the second capacitor, and serve as a second connection end of a resonance circuit for being connected to a primary winding of a transformer; a secondary winding of the transformer is connected to an input side of a rectification circuit; and an output side of the rectification circuit and an input side of an inverter circuit serve as a second external connection end and a first external connection end of the wide-range efficient isolated bidirectional converter, respectively.

2. The wide-range efficient isolated bidirectional converter according to claim 1, wherein the inverter circuit comprises four switch tubes; each two switch tubes are connected in series to form a bridge arm; two ends of two bridge arms are used as a first external connection end of the wide-range efficient isolated bidirectional converter after the two bridge arms are connected in parallel; and the first inductor and first capacitor are respectively connected to middle points of the two bridge arms.

3. The wide-range efficient isolated bidirectional converter according to claim 1, wherein the inverter circuit comprises two capacitors and two switch tubes; the two capacitors and the two switch tubes are respectively connected in series to form a bridge arm; two ends of two bridge arms are used as a first external connection end of the wide-range efficient isolated bidirectional converter after the two bridge arms are connected in parallel; and the first inductor and the first capacitor are respectively connected to the middle points of the two bridge arms.

4. The wide-range efficient isolated bidirectional converter according to claim 1, wherein the inverter circuit comprises two switch tubes; the two switch tubes are connected in series to form a bridge arm; and the first inductor and the first capacitor are respectively connected to a middle point of the bridge arm and a lowermost end/an uppermost end of the bridge arm.

5. The wide-range efficient isolated bidirectional converter according to claim 1, wherein the inverter circuit comprises two capacitors and four switch tubes; the two capacitors and the four switch tubes are respectively connected in series to form a first bridge arm and a second bridge arm; after the first bridge arm and the second bridge arm are connected in parallel, two ends thereof serve as a first external connection end of the wide-range efficient isolated bidirectional converter; the middle point of the first bridge arm is connected to the middle point of the second bridge arm; and the first inductor and the first capacitor are respectively connected to an upper bridge arm and a lower bridge arm of the second bridge arm.

6. The wide-range efficient isolated bidirectional converter according to claim 1, wherein the inverter circuit comprises two capacitors, four switch tubes, two diodes and a tenth capacitor; the two capacitors and the four switch tubes are respectively connected in series to form a bridge arm; two ends of the two bridge arms are used as a first external connection end of the wide-range efficient isolated bidirectional converter after the two bridge arms are connected in parallel; the first inductor and first capacitor are respectively connected to the middle points of the two bridge arms; after the two diodes are connected in series, the two diodes are connected in parallel to the tenth capacitor, and are connected in parallel to two switch tubes in the middle of the bridge arm formed by four switch tubes being connected in series; and the middle point of the bridge arm formed by the two capacitors is connected to a connection point between the two diodes connected in series.

7. The wide-range efficient isolated bidirectional converter according to claim 1, wherein the rectification circuit comprises four switch tubes; each two switch tubes are connected in series to form a bridge arm; two ends of the two bridge arms are used as a second external connection end of the wide-range efficient isolated bidirectional converter after the two bridge arms are connected in parallel; and a same-name end and a different-name end of the secondary winding of the transformer are respectively connected to the middle points of the two bridge arms.

8. The wide-range efficient isolated bidirectional converter according to claim 1, wherein the wide-range efficient isolated bidirectional converter further comprises a first filter capacitor and a second filter capacitor; two ends of the first filter capacitor are connected to an input side of the inverter circuit; and two ends of the second filter capacitor are connected to an output side of the rectification circuit.

9. A wide-range efficient isolated bidirectional converter, wherein the wide-range efficient isolated bidirectional converter comprises an inverter circuit, a resonance circuit, a transformer and a rectification circuit; the resonance circuit comprises a first capacitor, a second capacitor, a first inductor, a second inductor, and a third inductor; one ends of the first inductor and the second inductor are both connected to one ends of the first capacitor and the second capacitor, and the other end of the first inductor is connected to one end of the third inductor and, together with the other end of the first capacitor, serves as a first connection end of the resonance circuit from being connected to the inverter circuit; the other end of the second inductor is connected to the other end of the third inductor and, together with the other end of the second capacitor, serves as a second connection end of the resonance circuit for being connected to a primary winding of the transformer; a secondary winding of the transformer is connected to an input side of the rectification circuit; and an output side of the rectification circuit and an input side of the inverter circuit are respectively used as a second external connection end and a first external connection end of the wide-range efficient isolated bidirectional converter.

10. A wide-range efficient isolated bidirectional converter, wherein the wide-range efficient isolated bidirectional converter comprises an inverter circuit, a resonance circuit, a transformer, and a rectification circuit; the resonance circuit comprises a first capacitor, a second capacitor, a first inductor, a second inductor, and a third inductor; one end of the first inductor is connected to one ends of the first capacitor and the third inductor, one end of the second inductor is connected to the other end of the third inductor and one end of the second capacitor; the other end of the first inductor is connected to the other end of the second inductor and, together with the other end of the first capacitor, serves as a first connection end of the resonance circuit for being connected to the inverter circuit; the other end of the first inductor and the other end of the second capacitor serve as a second connection end of the resonance circuit, and are connected to a primary winding of the transformer; ; a secondary winding of the transformer is connected to an input side of the rectification circuit; and an output side of the rectification circuit and an input side of the inverter circuit are respectively used as a second external connection end and a first external connection end of the wide-range efficient isolated bidirectional converter.
